(19) United States
(12) Patent Application Publication
(10) Pub. No.: US 2018/0224895 A1
(43) Pub. Date: Aug. 9, 2018

(54) MOBILE ELECTRONIC DEVICE

(71) Applicant: SOLVAY SPECIALTY POLYMERS ITALY S.P.A., Bollate (IT)

(72) Inventors: Geert J. VERFAILLIE, Parike (BE); Kun LI, Media, PA (US); Keshav GAUTAM, Duluth, GA (US)

(73) Assignee: SOLVAY SPECIALTY POLYMERS ITALY S.P.A., Bollate (IT)

(21) Appl. No.: 15/749,363

(22) PCT Filed: Jul. 26, 2016
(86) PCT No.: PCT/EP2016/067760

§ 371 Date: Jan. 31, 2018

Related U.S. Application Data
(60) Provisional application No. 62/199,523, filed on Jul. 31, 2015.

(51) Int. Cl. G06F 1/16; C08L 27/16; G06F 1/18; H04M 1/18

(52) U.S. Cl. CPC G06F 1/1656; C08L 27/16; C08L 2205/02; H04M 1/185; G06F 1/182

(57) ABSTRACT

The invention pertains to a mobile electronic device comprising at least one part made of a fluoropolymer composition comprising at least one at least one vinylidene fluoride polymer, at least one acrylic elastomer and optionally at least one methyl methacrylate polymer, to a method for the manufacture of said part and to a method for the manufacture of said mobile electronic device.

### CROSS-REFERENCE TO RELATED APPLICATION

This application claims priority to U.S. provisional application No. 62/199523 filed on Jul. 31, 2015, the whole content of this application being incorporated herein by reference for all purposes.

### TECHNICAL FIELD

The invention pertains to a mobile electronic device comprising at least one part made of a fluoropolymer composition, to a method for the manufacture of said part, and to a method of manufacturing a mobile electronic device using said part.

### BACKGROUND ART

Nowadays, mobile electronic devices such as mobile phones, personal digital assistants (PDAs), laptop computers, MP3 players, and so on, are in widespread use around the world. Mobile electronic devices are getting smaller and lighter for even more portability and convenience, while at the same time becoming increasingly capable of performing more advanced functions and services, both due to the development of the devices and the network systems.

While for convenience sake, it is often desirable that these devices be small and lightweight, they still need to possess a certain structural strength so that they will not be damaged in normal handling and occasional drops. Thus, usually built into such devices are structural parts whose primary function is to provide strength and/or rigidity and/or impact resistance to the device, and possibly also provide mounting places for various internal components of the device and/or part or all of the mobile electronic device case (outer housing), while ensuring electrical insulation/electrical shield among components. While in the past, low density metals such as magnesium or aluminium, were the materials of choice, synthetic resins have progressively come as at least partial replacement, for costs reasons (some of these less dense metals such as magnesium are somewhat expensive, and manufacturing the often small and/or intricate parts needed is expensive), for overriding design flexibility limitations, for further weight reduction, and for providing un-restricted aesthetic possibilities, thanks to the colorability of the same. Plastic parts of such devices are hence made from materials that are easy to process into various and complex shapes, are able to withstand the rigors of frequent use, including outstanding impact resistance, generally possess electrical insulating capabilities, and which can meet challenging aesthetic demands while not interfering with their intended operability.

Nevertheless, in certain cases, plastics may not have the strength and/or stiffness to provide for all-plastic structural parts in mobile electronic devices, and metal/synthetic resins assemblies are often encountered.

In these cases, metal parts, e.g. aluminum parts and/or aluminum/plastic composite parts present in mobile devices, are submitted generally to anodization, i.e. to electro chemical processes where the aim is to build an oxide layer on the aluminum surface, notably through the use of aggressive chemicals. In this regards, anodization being performed on parts already comprising/assembled to polymeric elements, polymeric materials used are required to exhibit excellent chemical resistance to various aggressive acids.

As said, it is desirable that such plastic materials for mobile devices have good impact resistance, tensile strength, stiffness and that they exhibit ability to be easily shaped, e.g. by injection molding, into the intended complex shape, designed to be assembled with minimum tolerance with a large number of additional structural and functional components.

An additional requirement for plastics material used in mobile electronics part is that they shall be resistant to staining agents that are often put in contact with these portable electronic devices housings. Typical staining agents include: makeup (such as lipstick, lip gloss, lip liner, lip plumper, lip balm, foundation, powder, blush), artificial or natural colorants (such as those found in soft drinks, coffee, red wine, mustard, ketchup and tomato sauce), dyes and pigments (such as those found in dyed textiles and leather, used for the manufacture of portable electronic devices housings). In contact with these staining agents, the portable electronic devices housings maybe easily stained: anti-stain properties are hence much appreciated for maintaining aesthetic appearance of said portable devices, in particular when the same are bright coloured or in shades of white or clear colours.

Providing a polymeric composition fulfilling all afore-mentioned requirements, that is to say possessing adequate mechanical performances for ensuring structural support (tensile strength) and yet a certain flexibility for enabling mounting/assembling (elongation at break), able to withstand to impact and to aggressive chemicals, having colorability and stain and UV-resistance is a continuous challenge in this field, and while solutions based on a variety of plastics have already been attempted, still continuous improvements to reach unmet challenges are required.

### SUMMARY OF INVENTION

Within this frame, the present invention aims at providing a solution based on the use of a particular composition based on fluorinated polymers.

More specifically, the invention is directed, in a first aspect, to a mobile electronic device comprising at least one part made of a fluoropolymer composition [composition (C)], said composition comprising:

at least one at least one vinylidene fluoride polymer [polymer (F)] in an amount of from 50 to 95% wt;

at least one acrylic elastomer [elastomer (I)] in an amount of from 5 to 25% wt; and optionally

at least one methyl methacrylate polymer [polymer (M)] in an amount of at most 25% wt, the % wt being referred to the sum of weights of polymer (F), elastomer (I) and polymer (M).

A further object of the present invention is a method for manufacturing a part of a mobile electronic device, said method comprising: (i) providing a composition (C) comprising:

at least one at least one vinylidene fluoride polymer [polymer (F)] in an amount of from 50 to 95% wt;

at least one acrylic elastomer [elastomer (I)] in an amount of from 5 to 25% wt; and optionally

at least one methyl methacrylate polymer [polymer (M)] in an amount of at most 25% wt; and

(ii) moulding said composition (C) so as to provide said part.

Still another object of the invention is the manufacture of a mobile electronic device, said method including the steps of:

a. providing as components at least a circuit board, a screen and a battery;

b. providing at least one part made of the polymer composition (C), comprising:

at least one at least one vinylidene fluoride polymer [polymer (F)] in an amount of from 50 to 95% wt;

at least one acrylic elastomer [elastomer (I)] in an amount of from 5 to 25% wt; and optionally

at least one methyl methacrylate polymer [polymer (M)] in an amount of at most 25% wt; and

c. assembling at least one of said components with said part or mounting at least one of said components on said part.

The Applicant has surprisingly found that compositions (C), as above detailed, thanks to the incorporation of aforementioned amounts of elastomer (I) in the stiff vinylidene fluoride polymer matrix are delivering a particularly advantageous combinations of properties which make them particularly adapted for the manufacture of parts of mobile electronic devices. In particular parts of mobile electronic devices made from said composition (C) possess superior chemical resistance, excellent UV resistance and good mechanical properties, and simultaneously have outstanding impact resistance, and excellent colourability (improved lightness, easy colour matching, easy dispersion of pigments).

### DESCRIPTION OF EMBODIMENTS

The Mobile Electronic Device

The term “mobile electronic device” is intended to denote any electronic devices that are designed to be conveniently transported and used in various locations while exchanging/providing access to data, e.g. through wireless connections or mobile network connection. Representative examples of mobile electronic devices include mobile phones, personal digital assistants, laptop computers, tablet computers, radios, cameras and camera accessories, watches, calculators, music players, global positioning system receivers, portable games, hard drives and other electronic storage devices, and the like.

The at least one part of the mobile electronic device according to the present invention may be selected from a large list of articles such as fitting parts, snap fit parts, mutually moveable parts, functional elements, operating elements, tracking elements, adjustment elements, carrier elements, frame elements, switches, connectors and (internal and external) components of housing, which can be notably produced by injection molding, extrusion or other shaping technologies.

In particular, the polymer composition (C) is very well suited for the production of housing components of mobile electronic device.

Therefore, the at least one part of the mobile electronic device according to the present invention is advantageously a component of a mobile electronic device housing. By “mobile electronic device housing” is meant one or more of the back cover, front cover, antenna housing, frame and/or backbone of a mobile electronic device. The housing may be a single component-article or, more often, may comprise two or more components. By “backbone” is meant a structural component onto which other components of the device, such as electronics, microprocessors, screens, keyboards and keypads, antennas, battery sockets, and the like are mounted. The backbone may be an interior component that is not visible or only partially visible from the exterior of the mobile electronic device. The housing may provide protection for internal components of the device from impact and contamination and/or damage from environmental agents (such as liquids, dust, and the like). Housing components such as covers may also provide substantial or primary structural support for and protection against impact of certain components having exposure to the exterior of the device such as screens and/or antennas. Housing components may also be designed for their aesthetic appearance and touch.

In a preferred embodiment, the mobile electronic device housing is selected from the group consisting of a mobile phone housing, a tablet housing, a laptop computer housing and a tablet computer housing. Excellent results were obtained when the part of the mobile electronic device according to the present invention was a mobile phone housing.

The at least one part of the mobile electronic device according to the present invention is advantageously characterized by a thickness of a flat portion of said part being 0.9 mm or less, preferably 0.8 mm or less, more preferably 0.7 mm or less, still more preferably 0.6 mm or less and most preferably 0.5 mm or less on average. The term “on average” is herein intended to denote the average thickness of the part based on the measurement of its thickness on at least 3 points of at least one of its flat portions.

The Polymer (F)

The expression vinylidene fluoride polymer and polymer (F) are used within the frame of the present invention for designating polymers essentially made of recurring units, more that 50% by moles of said recurring units being derived from vinylidene fluoride (VDF).

The vinylidene fluoride polymer [polymer (F)] is preferably a polymer comprising:

(a′) at least 60% by moles, preferably at least 75% by moles, more preferably 85% by moles of recurring units derived from vinylidene fluoride (VDF);

(b′) optionally from 0.1 to 15%, preferably from 0.1 to 12%, more preferably from 0.1 to 10% by moles of recurring units derived from a fluorinated monomer different from VDF; and

(c′) optionally from 0.1 to 5%, by moles, preferably 0.1 to 3% by moles, more preferably 0.1 to 1% by moles of recurring units derived from one or more hydrogenated comonomer(s),

all the aforementioned % by moles being referred to the total moles of recurring units of the polymer (F).

The said fluorinated monomer is advantageously selected in the group consisting of vinyl fluoride (VF₁); trifluoroethylene (VF₃); chlorotrifluoroethylene (CTFE); 1,2-difluoroethylene; tetrafluoroethylene (TFE); hexafluoropropylene (HFP); perfluoro(alkyl)vinyl ethers, such as perfluoro(methyl)vinyl ether (PMVE), perfluoro(ethyl) vinyl ether (PEVE) and perfluoro(propyl)vinyl ether (PPVE); perfluoro(1,3-dioxole); perfluoro(2,2-dimethyl-1,3-dioxole) (PDD). Preferably, the possible additional fluorinated monomer is chosen from chlorotrifluoroethylene (CTFE), hexafluoroproylene (HFP), trifluoroethylene (VF3) and tetrafluoroethylene (TFE).

The choice of the said hydrogenated comonomer(s) is not particularly limited; alpha-olefins, (meth)acrylic monomers, vinyl ether monomers, styrenic mononomers may be used; nevertheless, to the sake of optimizing chemical resistance, embodiment's wherein the polymer (F) is essentially free from recurring units derived from said hydrogenated comonomer(s) are preferred.

Accordingly, the vinylidene fluoride polymer [polymer (F)] is more preferably a polymer consisting essentially of:

(a′) at least 60% by moles, preferably at least 75% by moles, more preferably 85% by moles of recurring units derived from vinylidene fluoride (VDF);

(b′) optionally from 0.1 to 15%, preferably from 0.1 to 12%, more preferably from 0.1 to 10% by moles of a fluorinated monomer different from VDF; said fluorinated monomer being preferably selected in the group consisting of vinylfluoride (VF₁), chlorotrifluoroethylene (CTFE), hexafluoropropene (HFP), tetrafluoroethylene (TFE), perfluoromethylvinylether (MVE), trifluoroethylene (TrFE) and mixtures therefrom,

all the aforementioned % by moles being referred to the total moles of recurring units of the polymer (F).

Defects, end chains, impurities, chains inversions or branchings and the like may be additionally present in the polymer (F) in addition to the said recurring units, without these components substantially modifying the behaviour and properties of the polymer (F).

As non-limitative examples of polymers (F) useful in the present invention, mention can be notably made of homopolymers of VDF, VDF/TFE copolymers, VDF/TFE/HFP copolymers, VDF/TFE/CTFE copolymers, VDF/TFE/TrFE copolymers, VDF/CTFE copolymers, VDF/HFP copolymers, VDF/TFE/HFP/CTFE copolymers and the like.

VDF homopolymers are particularly advantageous for being used as polymer (F) in the composition (C).

The melt index of the polymer (F) is advantageously at least 0.01, preferably at least 0.05, more preferably at least 0.1 g/10 min and advantageously less than 50, preferably less than 30, more preferably less than 20 g/10 min, when measured in accordance with ASTM test No. 1238, run at 230° C., under a piston load of 2.16 kg.

The melt index of the polymer (F) is advantageously at least 1, preferably at least 2, more preferably at least 5 g/10 min and advantageously less than 70, preferably less than 50, more preferably less than 40 g/10 min, when measured in accordance with ASTM test No. 1238, run at 230° C., under a piston load of 5 kg.

The polymer (F) has advantageously a melting point (Tₘ₂) advantageously of at least 120° C., preferably at least 125° C., more preferably at least 130° C. and of at most 190° C., preferably at most 185° C., more preferably at most 180° C., when determined by DSC, at a heating rate of 10° C./min, according to ASTM D 3418.

The Elastomer (I)

With regard to the expressions “acrylic elastomer” and “elastomer (I)”, these terms are intended hereby to denote any one of the following:

(i) elastomeric copolymers having glass transition temperature below 25° C., when measured according to according to ASTM D 3418, and comprising recurring units derived from one or more than one acrylic monomer selected from the group consisting of alkyl(meth)acrylates and acrylonitrile; and

(ii) core-shell elastomers, including a central core and a shell at least partially surrounding the core, said core and said shell having different monomeric composition, and at least one of them being of elastomeric nature with a glass transition temperature below 25° C., when measured according to according to ASTM D 3418, and at least one of them comprising recurring units derived from one or more than one acrylic monomer selected from the group consisting of alkyl(meth)acrylates and acrylonitrile.

Among elastomer copolymers (i), as above detailed, mention can be notably made of:

(i-A) elastomers consisting essentially of recurring units derived from acrylonitrile and recurring units derived from one or more than one monomer selected from the group consisting of ethylene, butadiene, isoprene, (meth)acrylate monomers and styrene; and

(i-B) elastomers consisting essentially of recurring units derived from one or more than one (meth)acrylate monomers and recurring units derived from one or more than one monomers selected from ethylene, butadiene, isoprene, acrylonitrile and styrene.

The expression (meth)acrylate monomers is hereby used to denote monomers of general formula CH₂═C(R_{M})—C(═O)—OR_{MA}, wherein R_{M} is H or CH₃ and R_{MA} is a hydrocarbon group, possibly comprising one or more than one heteroatoms selected from O, S, halogen or R_{MA} is H (i.e. providing for (meth)acrylic acid).

Hydrocarbon group R_{MA} is not particularly limited and encompasses notably alkyl groups (and in this case the (meth)acrylate monomer will be referred to as an alkyl (meth)acrylate), hydroxy-alkylgroups, epoxy-containing hydrocarbon groups, and the like.

Non-limitative examples of (meth)acrylate monomers wherein R_{MA} is an hydroxyl-alkylgroup are notably hydroxyethyl (meth)acrylate and hydroxypropyl (meth)acrylate isomers.

Examples of elastomers (i-B) are notably ethylene-acrylic ester-glycidyl methacrylate elastomers. Exemplary embodiments of this type of elastomers (i-B) are notably elastomers available from Arkema with trade mark Lotader®, and more specifically e.g. Lotader® AX 8900, a random terpolymer of ethylene, acrylic ester (24% wt) and glycidyl methacrylate (8% wt).

Core-shell elastomers are preferred for use in the composition (C).

As said these core-shell elastomers are provided in the form of primary particles having an average particle size of generally from 100 to 1000 nm, preferably of from 200 to 650 nm.

According to a preferred embodiment's, the core-shell elastomers are composed of an elastomeric core and of a thermoplastic shell.

The elastomeric core is generally selected from:

elastomeric diene homopolymers or copolymers, generally selected from the group consisting of isoprene or butadiene homopolymers, isoprene copolymers with at most 30 mol percent of a vinyl monomer and butadiene copolymers with at most 30 mol percent of a vinyl monomer. The vinyl monomer may be styrene, an alkyl styrene, acrylonitrile or a (meth)acrylate monomer, as above detailed, preferably an alkyl(meth)acrylate;

elastomeric homopolymers of alkyl(meth)acrylate different from MMA and copolymers of said alkyl(meth)acrylate different from MMA with at most 30 mol percent of a monomer chosen from another alkyl(meth)acrylate, and a vinyl monomer. Advantageously, the alkyl(meth)acrylate different from MMA is butyl acrylate. The vinyl monomer may be styrene, an alkyl styrene, acrylonitrile, butadiene or isoprene.

The elastomeric core of the core-shell copolymer may be completely or partly crosslinked.

To achieve crosslinking of the elastomeric core, a possible practice is to incorporate at least one polyfunctional monomer during polymerization leading to said elastomeric core; it is possible for these polyfunctional monomers to be chosen from poly(meth)acrylic esters of polyols such as butylene di(meth)acrylate and trimethylolpropane trimethacrylate. Other suitable difunctional monomers are, for example, divinylbenzene, trivinylbenzene, vinyl acrylate and vinyl methacrylate.

The elastomeric core may also be crosslinked by introducing into it, by grafting or as comonomer during polymerisation, unsaturated functional monomers such as unsaturated carboxylic acid anhydrides, unsaturated carboxylic acids and unsaturated epoxides. For example, mention may be made of maleic anhydride, (meth)acrylic acid and glycidyl methacrylate.

The thermoplastic shell can be notably any of styrene, alkyl styrene or methyl methacrylate homopolymers or copolymers containing at least 70 mol percent of one of these monomers mentioned above and at least one comonomer chosen from the other monomers mentioned above, another alkyl(meth)acrylate, vinyl acetate and acrylonitrile. The shell may be functionalised by introducing thereinto, by grafting or as comonomer during polymerisation, unsaturated functional monomers such as unsaturated carboxylic acid anhydrides, unsaturated carboxylic acids and unsaturated epoxides. As examples, mention may be made of maleic anhydride, (meth)acrylic acid and glycidyl methacrylate.

Examples of elastomers (I) and their methods of preparation are notably described in the following patents U.S. Pat. No. 4,180,494 25 Dec. 1979; U.S. Pat. No. 4,096,202 20 Jun. 1978; U.S. Pat. No. 4,260,693 7 Apr. 1981; U.S. Pat. No. 3,287,443 22 Nov. 1966; U.S. Pat. No. 4,299,928 10 Nov. 1981; U.S. Pat. No. 3,985,704 12 Oct. 1976.

Advantageously, the core represents 70 to 90 percent and the shell 30 to 10 percent by weight of the core-shell elastomer.

As examples of a specific core-shell elastomer which can be used, mention may be made of:

(1) a core-shell elastomer which is made of:

(i) from 25 to 95 weight percent of an acrylic rubber core:

said core comprising from 90 to 100% wt of recurring units derived from a C₁-C₆ acrylate (preferably butyl acrylate);

said core being possibly cross-linked with 0.1 to 5% wt of a cross-linking monomer having a plurality of addition polymerizable reactive groups, all of which polymerize at substantially same reaction rate, preferably selected from poly acrylic and poly methacrylic esters of polyols (preferably butylene diacrylate, butylene dimethacrylate, trimethylol propane trimethacrylate); di- and tri-vinyl benzene, vinyl acrylate and vinyl methacrylate; and

said core possibly further containing 0.1 to 5% wt of a graft-linking monomer, i.e. a polyethylenically unsaturated monomer having a plurality of addition polymerizable reactive groups, at least one of which polymerizing at substantially lower rate of said reactive group, so providing a residual level of unsaturation in the elastomeric phase to enable grafting of the thermoplastic shell, said graft-linking monomer being preferably selected from allyl-group containing monomers, in particular allyl esters of ethylenically unsaturated acids (preferably allyl acrylate, allyl methacrylate, diallyl maleate, diallyl fumarate, diallyl itaconate); and

(ii) from 75 to 5 weight percent of a thermoplastic shell, said shell consisting of a polymer comprising at least 70% weight of recurring units derived from a C₁ to C₄ alkyl methacrylate (preferably methyl methacrylate), possibly in combination with less than 30% wt of recurring units derived from any of styrene, acrylonitrile, alkyl acrylate, allyl methacrylate, diallyl methacrylate;

(2) a core-shell elastomer which is made of:

(i) from 25 to 95 weight percent of a 1,3-butadiene elastomer-based core:

said core comprising at least 70% wt of recurring units derived from 1,3-butadiene, and less than 30% wt of recurring units derived from monomers other than 1,3-butadiene, selected from the group consisting of styrene, acrylonitrile and methyl methacrylate (preferably styrene);

said core possibly comprising minor amounts (e.g. of 0.01 to 1% wt) of recurring units from one or more polyunsaturated cross-linking monomers, e.g. divinylbenzene; and

(ii) from 75 to 5 weight percent of a thermoplastic shell, said shell being made of any of (k) a methyl methacrylate homopolymer, possibly modified with a minor amount (e.g. from 0.1 to 1% wt) of a cross-linking monomer, preferably selected from poly acrylic and poly methacrylic esters of polyols (preferably butylene diacrylate, butylene dimethacrylate, trimethylol propane trimethacrylate), (kk) a polymer of styrene, acrylonitrile and methylmethacrylate, and (kkk) a styrene homopolymer, possibly modified with a minor amount (e.g. from 0.1 to 1% wt) of a cross-linking monomer, preferably selected from divinylbenzene;

(3) a core-shell elastomer which comprises

(j) 75 to 80 parts by weight of a core comprising at least 94% wt of recurring units derived from 1,3-butadiene, 5% wt or less of recurring units derived from styrene, and 0.5 to 1% wt percent of recurring units derived from divinylbenzene and

(jj) 25 to 20 parts by weight of two shells, generally of identical weight fraction, the inner one made of polystyrene and the other outer one made of a methyl methacrylate homopolymer, possibly modified with a minor amount (e.g. from 0.1 to 1% wt) of a cross-linking monomer, preferably selected from poly acrylic and poly methacrylic esters of polyols (preferably butylene diacrylate, butylene dimethacrylate, trimethylol propane trimethacrylate).

There are also other types of core-shell copolymers such as hard/soft/hard copolymers, that is to say they have, in this order, a hard core, a soft shell and a hard shell. The hard parts may comprise the polymers of the shell of the above soft/hard copolymers and the soft part may comprise the polymers of the core of the above soft/hard copolymers. Non-limiting examples of such core-shell polymers comprise in order:

a core made of a methyl methacrylate/ethyl acrylate copolymer;

a shell made of a butyl acrylate/styrene copolymer; and

a shell made of a methyl methacrylate/ethyl acrylate copolymer.

There are also other types of core-shell copolymers such as hard (core)/soft/semi-hard copolymers. Compared with the previous ones, the difference stems from the “semi-hard” outer shell which comprises two shells, one being the intermediate shell and the other the outer shell. The intermediate shell is a copolymer of methyl methacrylate, styrene and at least one monomer chosen from alkyl acrylates, butadiene and isoprene. The outer shell is a PMMA homopolymer or copolymer. Non-limiting examples of such copolymers comprise in order:

a core made of a methyl methacrylate/ethyl acrylate copolymer;

a shell made of a butyl acrylate/styrene copolymer;

a shell made of a methyl methacrylate/butyl acrylate/styrene copolymer; and

a shell made of a methyl methacrylate/ethyl acrylate copolymer.

Exemplary core-shell embodiments which have been found particularly adapted for use in the composition (C) are notably PARALOID® EXL-23XX/33XX acrylic core-shell impact modifiers, commercially available from Dow Chemicals Company, and more precisely:

PARALOID® EXL-2314, which is a core-shell impact modifier provided under the form of particles, comprising a poly(butyl acrylate)-based elastomeric core and a methyl methacrylate/glycidyl methacrylate copolymer as grafted shell possessing epoxy functionalities; and

PARALOID® EXL-3361, which is a core-shell impact modifier provided under the form of particles, comprising a poly(butyl acrylate)-based elastomeric core and a methyl methacrylate-based shell, devoided of epoxy functionalities.

The Polymer (M)

With regard to the expressions “methyl methacrylate polymer” or “polymer (M)”, these terms are hereby used to denote methyl methacrylate homopolymers and methyl methacrylate copolymers which have a preponderant content of methyl methacrylate and a minor content of other monomers selected from alkyl(meth)acrylates, acrylonitrile, butadiene, styrene and isoprene.

Advantageous results are obtained with homopolymers of methyl methacrylate and copolymers of methyl methacrylate and of C₂-C₆ alkyl acrylates. Outstanding results are obtained with homopolymers of methyl methacrylate and copolymers of methyl methacrylate and of C₂-C₄ alkyl acrylates such as, for example, butyl acrylate. The methyl methacrylate content of the copolymers is generally at least approximately 55% by weight and preferably at least approximately 60% by weight. It generally does not exceed approximately 90% by weight; in most cases it does not exceed 80% by weight.

Advantageously, the polymer (M) may contain 0 to 20 percent and preferably 5 to 15 percent of at least one of methyl acrylate, ethyl acrylate and butyl acrylate, by weight of polymer (M).

The polymer (M) may be functionalised, that is to say it contains, for example, acid, acid chloride, alcohol or anhydride functional groups. These functional groups may be introduced by grafting or by copolymerisation. Advantageously, this is an acid functional group provided by the acrylic acid comonomer. Two neighbouring acrylic acid functional groups may lose water to form an anhydride. The proportion of functional groups may be between 0 and 15 percent by weight of the polymer (M) containing the optional functional groups.

The polymer (M) has advantageously a glass transition temperature of at least 80° C., preferably of at least 85° C., more preferably of at least 100° C., when measured according to according to ASTM D 3418.

According to certain preferred embodiments, the polymer (M) is polymethylmethacrylate homopolymer.

The Composition (C)

The amount of polymer (F) in the composition (C) is of at least 50% wt, preferably at least 60% wt, more preferably at least 65% wt, most preferably of at least 70% wt; and/or is of at most 95% wt, preferably at most 90% wt, with respect to the total weight of polymer (F), elastomer (I) and polymer (M).

The amount of elastomer (I) in the composition (C) is of at least 5% wt, preferably of at least 10% wt; and/or is of at most 25% wt, preferably at most 20% wt, with respect to the total weight of polymer (F), elastomer (I) and polymer (M).

When polymer (M) is present, the amount of polymer (M) in the composition (C) is generally of at least 5% wt, preferably at least 10% wt, and/or of at most 25% wt, preferably at most 20% wt, more preferably at most 15% wt, with respect to the total weight of polymer (F), elastomer (I) and polymer (M).

The composition (C) may further comprise, in addition to polymer (F), elastomer (I) and polymer (M) one or more additives, notably one or more additives selected from the group consisting of pigments, processing aids, plasticizers, stabilizers, mold release agents, and the like.

When present, additives are generally comprised in the composition (C) in amounts not exceeding 10 parts, preferably not exceeding 5 parts per 100 weight parts of polymer (F), elastomer (I) and polymer (M).

Preferred embodiments are those wherein the composition (C) consists of polymer (F), elastomer (I), polymer (M) and optionally from 0 to 10 weight parts, per 100 weight parts of polymer (F), elastomer (I) and polymer (M), of one or more than one additive.

To the sake of aesthetic appearance is generally understood that the composition will comprise at least one additive selected from pigments.

Pigments useful in composition (C) are generally selected among oxides, sulfides, oxides hydroxides, silicates, sulfates, titanates, phosphates, carbonates and mixtures thereof.

White inorganic pigments are preferred in the composition (C) when aiming at providing white parts.

The Applicant has found that white parts made from the composition (C) exhibit improved lightness, which provide for more flexibility to possibly introduce coloured pigments for fine colour matching, without impairing brightness of colours.

Among white pigments suitable for the composition of the invention mention can be made of TiO₂ pigments (e.g. rutile, anatase), Zinc oxide (ZnO) pigments (e.g. Zinc white, Chinese white or flowers of Zinc), Zinc sulphide (ZnS) pigments, lithopone (mixed pigment produced from Zinc sulphide and barium sulphate) pigments, white lead pigments (basic lead carbonate), Barium sulphate, and corresponding complex pigments obtained from coating of above mentioned pigments on suitable inorganic carriers, e.g. silicates, alumino-silicates, mica and the like.

Particularly preferred pigments are Zinc oxide and Zinc sulphide pigments, which have been shown to produce, when incorporated in the composition (C) moulded parts possessing outstanding whiteness.

As said above, it may be appropriate, in certain cases, to add minor amounts of coloured pigments in combination with any of the white pigment mentioned above, so as to tune colour coordinate towards a target white colour, and/or for reducing yellowness or for any other reason.

Coloured pigments useful in the composition (C) notably include, or will comprise, one or more of the following: Artic blue #3, Topaz blue #9, Olympic blue #190, Kingfisher blue #211, Ensign blue #214, Russet brown #24, Walnut brown #10, Golden brown #19, Chocolate brown #20, Ironstone brown #39, Honey yellow #29, Sherwood green #5, and Jet black #1 available from Shepard Color Company, Cincinnati, Ohio, USA.; black F-2302, blue V-5200, turquoise F-5686, green F-5687, brown F-6109, buff F-6115, chestnut brown V-9186, and yellow V-9404 available from Ferro Corp., Cleveland, Ohio, USA and METEOR® pigments available from Englehard Industries, Edison, N.J. USA; ultramarine blue #54, ultramarine violet # 5012, commercially available from Hollidays Pigments International.

Within this context, hence, preferred embodiments are those wherein the composition (C) consists of polymer (F), elastomer (I), polymer (M) and from 0.01 to 10 weight parts, per 100 weight parts of polymer (F), elastomer (I) and polymer (M), of one or more than one additive, at least one of said additives being a pigment, as above detailed, said at least one pigment being used in an amount of from 0.01 to 5, preferably of from 0.01 to 3 weight parts, per 100 weight parts of polymer (F), elastomer (I) and polymer (M).

The Method for Manufacturing the Part

A further object of the present invention is a method for manufacturing a part of a mobile electronic device, as above detailed, said method comprising:

(i) providing a composition (C) comprising:

at least one polymer (F), as above detailed, in an amount of from 50 to 95% wt;

at least one elastomer (I), as above detailed, in an amount of from 5 to 25% wt; and

optionally, at least one polymer (M), as above detailed, in an amount of at most 25% wt; and optionally additional additives, as above detailed,

(ii) moulding said composition (C) so as to provide said part.

The step (i) of providing a composition (C) generally includes at least one step of mixing polymer (F), elastomer (I), possibly polymer (M). Mixing can be effected using standard mixing devices; generally polymer (F), elastomer (I) and polymer (M) (when present) are mixed in the molten form. Mixing is generally accomplished using extruder devices, with twin-screw extruders being preferred.

It is hence common practice of providing the composition (C) in step (i) under the form of pellets.

The composition (C) is moulded in step (ii) to provide said part. Technique used for moulding is not particularly limited; standard techniques including shaping composition (C) in a molten/softened form can be advantageously applied, and include notably compression moulding, extrusion moulding, injection moulding, transfer moulding and the like.

It is nevertheless generally understood that especially when said part of the mobile electronic device possesses a complex design, injection moulding technique is the most versatile, and extensively used.

According to this technique, a ram or screw-type plunger is used for forcing a portion of composition (C) in its molten state into a mould cavity, wherein the same solidified into a shape that has confirmed to the contour of the mould. Then, the mould opens and suitable means (e.g. an array of pins, sleeves, strippers, etc.) are driven forward to demould the article. Then, the mould closes and the process is repeated.

In another embodiment of the present invention, the method for manufacturing a part of a mobile electronic device includes in step (ii) a step of machining of a standard shaped article so as to obtain said part having different size and shape from said standard shaped article. Non limiting examples of said standard shaped articles include notably a plate, a rod, a slab and the like. Said standard shaped parts can be obtained by any processing technique, including notably extrusion or injection moulding of the polymer composition (C).

The parts of the mobile electronic devices according to the present invention may be coated with metal by any known methods for accomplishing that, such as vacuum deposition (including various methods of heating the metal to be deposited), electroless plating, electroplating, chemical vapor deposition, metal sputtering, and electron beam deposition. Hence, the method, as above detailed, may additionally comprise at least one additional step comprising coating at least one metal onto at least a part of the surface of the said part.

Although the metal may adhere well to the parts without any special treatment, usually some well known in the art method for improving adhesion will be used. This may range from simple abrasion of the surface to roughen it, addition of adhesion promotion agents, chemical etching, functionalization of the surface by exposure to plasma and/or radiation (for instance laser or UV radiation) or any combination of these.

Also, some of the metal coating methods comprise at least one step where the part is immersed in an acid bath. More than one metal or metal alloy may be plated onto the parts made of the polymer composition (C), for example one metal or alloy may be plated directly onto the surface because of its good adhesion, and another metal or alloy may be plated on top of that because it has a higher strength and/or stiffness. Useful metals and alloys to form the metal coating include copper, nickel, iron-nickel, cobalt, cobalt-nickel, and chromium, and combinations of these in different layers. Preferred metals and alloys are copper, nickel, and iron-nickel, and nickel is more preferred. The surface of the part may be fully or partly coated with metal. In different areas of the part the thickness and/or the number of metal layers, and/or the composition of the metal layers may vary. The metal may be coated in patterns to efficiently improve one or more properties in certain sections of the part.

The part, as obtained from the method above, is generally assembled with other components in order to manufacture a mobile electronic device.

The Method for the Manufacture of the Mobile Electronic Device

Still another object of the invention is the manufacture of a mobile electronic device, said method including the steps of:

a. providing as components at least a circuit board, a screen and a battery;

b. providing at least one part made of the polymer composition (C), as above detailed;

c. assembling at least one of said components with said part or mounting at least one of said components on said part.

Should the disclosure of any patents, patent applications, and publications which are incorporated herein by reference conflict with the description of the present application to the extent that it may render a term unclear, the present description shall take precedence.

The invention will now be described with reference to the following examples, whose purpose is merely illustrative and not intended to limit the scope of the invention.

Raw Materials

SOLEF® 6008/0001 PVDF is a low-viscosity PVDF homopolymer having a melt flow rate (at 230° C./2.16 kg, ASTM D1238) of about 5.5 to 11 g/10 min, and a melt flow rate (230° C./5 kg) of 16 to 30 g/10 min, commercially available from Solvay Specialty Polymers (6008, herein after).

PARALOID® EXL 2314 elastomer is a core/shell impact modifier comprising a poly(butyl acrylate) elastomeric core and a methyl methacrylate/glycidyl methacrylate grafted shell, commercially available from The Dow Chemical Company (2314, herein after).

PARALOID® EXL 2300 elastomer is a core/shell impact modifier comprising a poly(butyl acrylate) elastomeric core and a methyl methacrylate grafted shell, commercially available from The Dow Chemical Company (2300, herein after).

OPTIX® CA51 PMMA is a polymethylmethacrylate homopolymer having a melt from rate (230° C./3.8 kg, ASTM D1238) of about 15.0 g/10 min, commercially available from Plaskolite, Inc (CA51, herein after).

SACHTOLITH® HD-S white pigment is synthetic micronized ZnS (ZnS: >98% wt, primarily of polycrystalline wurtzite form of ZnS), organically coated; it is commercially available from Sachtleben Chemie GmbH (ZnS, herein after).

BLEU D′OUTREMER 54 is a mineral pigment commercially available from Holiday pigments (Blue 54, herein after)

ULTRAMARINE VIOLET 5012 is a mineral pigment commercially available from Holliday Pigments International (Violet 5012, herein after)

General Procedure for Preparation of Compositions for the Manufacture of Injection Moulding Parts

The ingredients, as detailed in Table 1, were compounded using a ZSK30 twin extruder, so as to obtain pellets, by extruding at a temperature of about 200° C., with a screw speed of 200 rpm at a throughput of 15 kg/h.

TABLE 1

| | | | | | | |
|---|---|---|---|---|---|---|
| Ex. 1C | Ex. 2 | Ex. 3 | Ex. 4 | Ex. 5 | Ex. 6 | Ex. 7 |

Composition in % by weight (based on total weight of composition)

| | | | | | | | |
|---|---|---|---|---|---|---|---|
| 6008 | 99.0% | 79.0% | 79.0% | 69.0% | 84.0% | 79.0% | 79.0% |
| 2314 | | 20.0% | 20.0% | 20.0% | 15.0% | 15.0% | |
| 2300 | | | | | | | 20.0% |
| CA51 | | | | 10.0% | | 5.0% | |
| ZnS | 1.0% | 1.0% | 1.0% | 1.0% | 1.0% | 1.0% | 1.0% |
| BLEU 54 | 0.005% | 0.005% | | | | | |
| VIOLET | 0.003% | 0.003% | | | | | |
| 5012 | | | | | | | |

General Procedure for Injection Moulding of Parts

Pellets as obtained by extrusion were fed to an Engel E-Motion 200/100 injection molding device for the manufacture of injected parts having ASTM tensile bar shape, according to ASTM D790. The injection molding device used is equipped with a screw extruder barrel and a mould with clamping force up to 1000 kN, and melt pressure controller up to 2500 bar.

Injection molding conditions were such that melt temperature was about 190-210° C., and mold temperature was set to 90° C.

Injection molding tests were conclusive for demonstrating that the introduction of elastomer (I) was not detrimentally affecting processability via injection molding techniques: injection pressures in otherwise consistent injection molding conditions, were not affected by the addition to the polymer (F) of elastomer (I), possibly in combination with polymer (M).

Properties of Injection Molded Specimens—Mechanical Properties

Injection molded specimens were tested for their tensile strength (according to ASTM D638), and for their impact resistance (according to Notched IZOD technique, pursuant to ASTM D 254 A at 23° C.). Results are summarized in table below.

TABLE 2

| Tensile | | | | | | | |
|---|---|---|---|---|---|---|---|
| properties | | | | | | | |
| (DAM) | Ex. 1C | Ex. 2 | Ex. 3 | Ex. 4 | Ex. 5 | Ex. 6 | Ex. 7 |
| Stress at | 32.0 | 28.4 | 31.2 | 28.2 | 31.8 | 29.7 | 29.5 |
| Break | | | | | | | |
| (MPa) | | | | | | | |
| Strain at | 30.1 | 147.0 | 47.9 | 105.1 | 33.0 | 48.9 | 36.1 |
| Break (%) | | | | | | | |
| STRESS | 54.0 | 29.6 | 36.6 | 32.0 | 44.3 | 42.1 | 42.9 |
| AT YIELD | | | | | | | |
| (Mpa) | | | | | | | |
| Strain at | 7.6 | 6.4 | 6.8 | 6.0 | 7.0 | 7.8 | 7.3 |
| Yield (%) | | | | | | | |
| Modulus | 2.07 | 1.20 | 1.48 | 1.36 | 1.73 | 1.65 | 1.68 |
| (GPa) | | | | | | | |

DAM: dry as molded

TABLE 3

| IZOD | Ex. 1C | Ex. 2 | Ex. 3 | Ex. 4 | Ex. 5 | Ex. 6 | Ex. 7 |
|---|---|---|---|---|---|---|---|
| IZOD | 100.1 | 562.1 | 939.3 | 1193.8 | 806.6 | n.a. | 782.3 |
| Notched | | | | | | | |
| (J/m) | | | | | | | |

n.a.: not available/not determined

n.a.: not available/not determined

Properties of Injection Molded Specimens—Colour/Rugosity/Stain Resistance

As-molded color of molded specimens was measured to assess the whiteness of the injection molded parts, when applying day-light type standard incident light (D65). The colour was measured according to the CIE L-a-b coordinates standard where the L* coordinate represents the lightness (black to white) scale, the a* coordinate represents the green-red chromaticity and the b* scale represents the blue-yellow chromaticity. The whiteness of the material is considered acceptable if the L* value is greater than 90.0 and the combined absolute values of the chromaticity coordinates a* and b* are less than 4.0 units. Of course, the whiteness maybe tuned adjusting the relative amounts of pigment in the compositions, which were in the tested compounds as low as about 1 phr, which is considered a low pigment load in this context.

TABLE 4

| | Ex. 1C | Ex. 2 | Ex. 3 | Ex. 4 | Ex. 5 | Ex. 6 | Ex. 7 |
|---|---|---|---|---|---|---|---|
| Run | COLOR (CIELAB 10°/D65) | | | | | | |
| L* | 91.94 | 93.38 | 96.62 | 96.63 | 96.18 | 96.5 | 94.54 |
| a* | −0.83 | −1.16 | −0.7 | −0.73 | −0.7 | −0.69 | −0.48 |
| b* | −0.98 | −2 | 1.91 | 1.46 | 1.99 | 1.55 | 1.98 |

Data above reproduced indicate that molded parts from the composition (C) including the elastomer (I) possess higher values of L*, i.e. higher lightness: this means that parts are “more white”, or more bright, and are hence more easily matched to a reference colour by appropriate addition of pigments, being understood that addition of coloured pigments generally shifts L* coordinate towards lower values, i.e. darker colours.

Rugosity was measured by a Surface Roughness Tester, Mitutoyo SJ-301 following ISO1997, determining rugosity amplitude parameters characterizing the surface based on the vertical deviations of the roughness profile from the mean line, and more specifically Ra, which is the arithmetic average of the absolute values of said deviations, and Rz, which is the average distance between the highest peak and lowest valley in each sampling length. Rugosity was determined on the injection molded specimens as such (DAM) and after ageing for 24 hours in a 70% H₂SO₄ solution in water (to test chemical resistance).

TABLE 5

| | | |
|---|---|---|
| Rugosity | Ex. 1C | Ex. 2 |

DAM

| | | |
|---|---|---|
| Ra. μm | 0.03 | 0.03 |
| Rz. μm | 0.26 | 0.27 |

After ageing70% H₂SO₄ - 24 h

| | | |
|---|---|---|
| Ra. μm | 0.04 | 0.03 |
| Rz. μm | 0.29 | 0.29 |

Rugosity paramenters, in particular Rz, which is most significant, are such to demonstrate that surface of parts made from composition (C) are not damaged by exposure to aggressive chemicals: in other terms the addition of elastomer (I) is not detrimentally affecting the chemical resistance of polymer (F), in the molded part.

Stain resistance against mustard and ketchup was evaluated in conditions defined below; results are reproduced in the Table below:

TABLE 6

| | |
|---|---|
| Ex. 1C | Ex. 2 |

65° C/90% RH - Mustard

| | | | |
|---|---|---|---|
| 5 | min | NO | NO |
| 15 | min | NO | NO |
| 1 | h | NO | VERY SLIGHT |
| 24 | h | VERY SLIGHT | SLIGHT |

65° C/90% RH - Ketchup

| | | | |
|---|---|---|---|
| 5 | min | NO | NO |
| 15 | min | NO | NO |
| 1 | h | NO | NO |
| 24 | h | NO | VERY SLIGHT |

Data summarized above indicate that parts made from composition (C) possess good resistance to staining agents, which made them appropriate for use in mobile electronic devices.

1. A mobile electronic device comprising at least one part made of a fluoropolymer composition (C), said composition (C) comprising:
at least one at least one vinylidene fluoride polymer (F) in an amount of from 50 to 95% wt;
at least one acrylic elastomer (I) in an amount of from 5 to 25% wt; and
optionally, at least one methyl methacrylate polymer (M) in an amount of at most 25% wt.

2. The mobile electronic device of claim 1, said device being selected from the group consisting of mobile phones, personal digital assistants, laptop computers, tablet computers, radios, cameras and camera accessories, watches, calculators, music players, global positioning system receivers, portable games, hard drives and other electronic storage devices.

3. The mobile electronic device according to claim 2, said part made of fluoropolymer composition (C) being selected from the group consisting of a mobile phone housing, a tablet housing, a laptop computer housing and a tablet computer housing.

4. The mobile electronic device of claim 1, wherein polymer (F) is a polymer consisting essentially of:
(a′) at least 60% by moles of recurring units derived from vinylidene fluoride (VDF);
(b′) optionally from 0.1 to 15% by moles of a fluorinated monomer different from VDF; said fluorinated monomer being selected from the group consisting of vinylfluoride (VF1), chlorotrifluoroethylene (CTFE), hexafluoropropene (HFP), tetrafluoroethylene (TFE), perfluoromethylvinylether (MVE), trifluoroethylene (TrFE) and mixtures thereof, all the aforementioned % by moles being with respect to the total moles of recurring units of the polymer (F).

5. The mobile electronic device of claim 1, wherein elastomer (I) is selected from the group consisting of:
(i) elastomeric copolymers having glass transition temperature below 25° C., when measured according to according to ASTM D 3418, and comprising recurring units derived from one or more than one acrylic monomer selected from the group consisting of alkyl(meth)acrylates and acrylonitrile; and
(ii) core-shell elastomers, including a central core and a shell at least partially surrounding the core, said core and said shell having different monomeric composition, and at least one of them being of elastomeric nature with a glass transition temperature below 25° C., when measured according to according to ASTM D 3418, and at least one of them comprising recurring units derived from one or more than one acrylic monomer selected from the group consisting of alkyl(meth)acrylates and acrylonitrile.

6. The mobile electronic device of claim 1, wherein elastomer (I) is selected from the group consisting of:
(i-A) elastomers consisting essentially of recurring units derived from acrylonitrile and recurring units derived from one or more than one monomer selected from the group consisting of ethylene, butadiene, isoprene, (meth)acrylate monomers and styrene; and
(i-B) elastomers consisting essentially of recurring units derived from one or more than one (meth)acrylate monomers and recurring units derived from one or more than one monomers selected from ethylene, butadiene, isoprene, acrylonitrile and styrene.

7. The mobile electronic device claim 1, wherein elastomer (I) is a core-shell elastomer selected from the group consisting of:
(1) a core-shell elastomer which is made of:
(i) from 25 to 95 weight percent of an acrylic rubber core:
said core comprising from 90 to 100% wt of recurring units derived from a C1-C6 acrylate;
said core being optionally cross-linked with 0.1 to 5% wt of a cross-linking monomer having a plurality of addition polymerizable reactive groups, all of which polymerize at substantially same reaction rate; and
said core optionally further containing 0.1 to 5 wt of a graft-linking monomer selected from polyethylenically unsaturated monomers having a plurality of addition polymerizable reactive groups, at least one of which polymerizing at substantially lower rate of said reactive group, providing a residual level of unsaturation in the elastomeric phase to enable grafting of the thermoplastic shell; and
(ii) from 75 to 5 weight percent of a thermoplastic shell, said shell consisting of a polymer comprising at least 70% weight of recurring units derived from a C1 to C4 alkyl methacrylate, optionally in combination with less than 30% wt of recurring units derived from any of styrene, acrylonitrile, alkyl acrylate, allyl methacrylate, or diallyl methacrylate;
(2) a core-shell elastomer which is made of:
(i) from 25 to 95 weight percent of a 1,3-butadiene elastomer-based core:
said core comprising at least 70% wt of recurring units derived from 1,3-butadiene, and less than 30% wt of recurring units derived from monomers other than 1,3-butadiene, selected from the group consisting of styrene, acrylonitrile and methyl methacrylate;
said core optionally comprising from 0.01 to 1% wt of recurring units from one or more polyunsaturated cross-linking monomers; and
(ii) from 75 to 5 weight percent of a thermoplastic shell, said shell being made of any of (k) a methyl methacrylate homopolymer, optionally modified with from 0.1 to 1% wt of a cross-linking monomer, (kk) a polymer of styrene, acrylonitrile and methylmethacrylate, and (kkk) a styrene homopolymer, optionally modified with from 0.1 to 1% wt of a cross-linking monomer;
(3) a core-shell elastomer which comprises
(j) 75 to 80 parts by weight of a core comprising at least 94% wt of recurring units derived from 1,3-butadiene, 5% wt or less of recurring units derived from styrene, and 0.5 to 1% wt percent of recurring units derived from divinylbenzene and
(jj) 25 to 20 parts by weight of two shells, the inner one made of polystyrene and the other outer one made of a methyl methacrylate homopolymer, optionally modified with from 0.1 to 1% wt of a cross-linking monomer.

8. The mobile electronic device of claim 1, wherein polymer (M) is selected from the group consisting of homopolymers of methyl methacrylate and copolymers of methyl methacrylate and of C2-C4 alkyl acrylates, wherein the methyl methacrylate content of the copolymers is at least 55% by weight and does not exceed approximately 90% by weight, with respect to the total weight of the copolymer.

9. The mobile electronic device of claim 1, wherein the amount of polymer (F) in composition (C) is of at least 50% wt and/or is of at most 95% wt, with respect to the total weight of polymer (F), elastomer (I) and polymer (M).

10. The mobile electronic device of claim 1, wherein the amount of elastomer (I) in the composition (C) is of at least 5% wt and/or is of at most 25% wt with respect to the total weight of polymer (F), elastomer (I) and polymer (M).

11. The mobile electronic device of claim 1, wherein polymer (M) is present, and wherein the amount of polymer (M) in composition (C) is of at least 5% wt and/or of at most 25% wt, with respect to the total weight of polymer (F), elastomer (I) and polymer (M).

12. The mobile electronic device of claim 1, wherein composition (C) further comprises, in addition to polymer (F), elastomer (I) and polymer (M), one or more additives selected from the group consisting of pigments, processing aids, plasticizers, stabilizers, and mold release agents.

13. The mobile electronic device of claim 1, wherein composition (C) consists of polymer (F), elastomer (I), polymer (M) and optionally from 0 to 10 weight parts, per 100 weight parts of polymer (F), elastomer (I) and polymer (M), of one or more than one additive.

14. A method for manufacturing a part of a mobile electronic device, said method comprising:
moulding a composition (C) so as to provide said part, said composition (C) comprising:
at least one at least one vinylidene fluoride polymer (F) in an amount of from 50 to 95% wt;
at least one acrylic elastomer (I) in an amount of from 5 to 25% wt; and
optionally, at least one methyl methacrylate polymer (M) in an amount of at most 25% wt.

15. A method for the manufacture of a mobile electronic device, said method comprising:
assembling at least one component selected from a circuit board, a screen and a battery with at least one part made of the polymer composition (C), or mounting at least one component on said part, said composition (C) comprising:
at least one at least one vinylidene fluoride polymer (F) in an amount of from 50 to 95% wt;
at least one acrylic elastomer (I) in an amount of from 5 to 25% wt; and
optionally, at least one methyl methacrylate polymer (M) in an amount of at most 25% wt.

16. The mobile electronic device of claim 4, wherein polymer (F) is a polymer consisting essentially of:
(a′) at least 85% by moles of recurring units derived from vinylidene fluoride (VDF);
(b′) optionally from 0.1 to 10% by moles of a fluorinated monomer different from VDF; said fluorinated monomer being selected from the group consisting of vinylfluoride (VF1), chlorotrifluoroethylene (CTFE), hexafluoropropene (HFP), tetrafluoroethylene (TFE), perfluoromethylvinylether (MVE), trifluoroethylene (TrFE) and mixtures thereof, all the aforementioned % by moles being with respect to the total moles of recurring units of the polymer (F).

17. The mobile electronic device of claim 8, wherein the methyl methacrylate content of the copolymers is at least 60% by weight and does not exceed 80% by weight, with respect to the total weight of the copolymer.

18. The mobile electronic device of claim 9, wherein the amount of polymer (F) in composition (C) is of at least 70% wt and at most 90% wt, with respect to the total weight of polymer (F), elastomer (I) and polymer (M).

19. The mobile electronic device of claim 10, wherein the amount of elastomer (I) in composition (C) is of at least 10% wt and at most 20% wt, with respect to the total weight of polymer (F), elastomer (I) and polymer (M).

20. The mobile electronic device of claim 11, wherein the amount of polymer (M) in composition (C) is of at least 10% wt and at most 15% wt, with respect to the total weight of polymer (F), elastomer (I) and polymer (M).
